(19) United States
(12) Patent Application Publication
(10) Pub. No.: US 2024/0230872 A9
(43) Pub. Date: Jul. 11, 2024

(54) SYSTEMS AND METHODS FOR IMPROVING ANGLE ESTIMATION ACCURACY FOR MILLIMETER-WAVE RADARS

(71) Applicants: Arizona Board of Regents on Behalf of Arizona State University, Tempe, AZ (US); Texas Instruments Incorporated, Dallas, TX (US)

(72) Inventors: Sule Ozev, Phoenix, AZ (US); Ferhat C. Ataman, Tempe, AZ (US); Chethan Kumar Y.B., Dallas, TX (US); Sandeep Rao, Dallas, TX (US)

(21) Appl. No.: 18/491,367

(22) Filed: Oct. 20, 2023

Related U.S. Application Data
(60) Provisional application No. 63/417,944, filed on Oct. 20, 2022.

(51) Int. Cl. G01S 13/42; G01S 7/35

(52) U.S. Cl. CPC G01S 13/42; G01S 7/356

(57) ABSTRACT

A radar system applies various angle correction processes with varying levels of computational overhead to reduce errors in angle estimation when processing received return signals. The various angle correction processes aim to overcome systematic errors affected by range migration through correction based on simulation or hardware measurements, through non-iterative refinement, iterative refinement, and/or a combination of correction and iterative refinement.

### CROSS-REFERENCE TO RELATED APPLICATIONS

This is a U.S. Non-Provisional Patent Application that claims benefit to U.S. Provisional Patent Application Ser. No. 63/417,944 filed 20 Oct. 2022, which is herein incorporated by reference in its entirety.

### FIELD

The present disclosure generally relates to radar-based object detection, and particularly to a system and associated method for improving angle estimation accuracy for millimeter-wave radar.

### BACKGROUND

Millimeter-wave radars are used to estimate the position of an object relative to the radar position. To specify the position of the object relative to the radar, the object's range R, azimuth angle θ, and elevation angle φ should be determined. Increasing receiver antenna number increases angle resolution. However, the estimation accuracy decreases as the objects' angle increases relative to the system. In addition, when the objects' angle increases, the signal-to-noise ratio reduces significantly, increasing uncertainty. Thus, angle estimation becomes much more challenging when the object is positioned at higher angles with respect to the radar.

It is with these observations in mind, among others, that various aspects of the present disclosure were conceived and developed.

### SUMMARY

In one embodiment, a system implementing a first solution process or a fourth solution process includes: a receiver operable to receive a return signal reflected from an object, the receiver including a plurality of virtual antennae; and a processor in communication with the receiver and a memory, the memory including instructions executable by the processor to:
determine, by a range and angle estimation process, an angle of arrival of the return signal, the angle of arrival being indicative of an angular position of the object; and
apply an angle correction function to the angle of arrival yielding a corrected angle of arrival, the angle correction function being a polynomial and including a plurality of correction coefficients, wherein the processor is operable to determine the plurality of correction coefficients through at least one of:
   simulation of a system model corresponding with a hardware of the receiver;
   post-production characterization of an error profile obtained using one or more calibration objects; and/or
   iterative fitting of the angle correction function to one or more candidate angles of arrival to determine an optimal set of correction parameters of the angle correction function.

In some embodiments, the angle of arrival being one of a plurality of candidate angles of arrival and the memory further including instructions executable by the processor to:
determine, based on an initial value of the angle of arrival of the return signal, an index error and an updated peak frequency for each respective virtual antenna;
generate an updated set of complex angle data at each updated peak frequency; and
apply a second Fourier Transform operation to the updated set of complex angle data to yield a set of updated transformed angle data.

In some embodiments, the memory further includes instructions executable by the processor to apply the range and angle estimation process including:
access a set of signal data indicative of the return signal;
apply a calibration process to the set of signal data yielding a set of calibrated data, the calibration process including a set of saved calibration coefficients that, when applied to the set of signal data, result in the set of calibrated data;
apply a first Fourier Transform operation to the set of calibrated data to yield a set of transformed data by frequency;
determine, based on the set of transformed data, a peak frequency of the return signal;
determine, based on the peak frequency of the return signal, a range of the object that reflected the return signal;
generate a set of complex angle data at the peak frequency;
apply a second Fourier Transform operation to the set of complex angle data to yield a set of transformed angle data; and
determine one or more peak values and an associated peak angle for each respective peak value from the set of transformed angle data, wherein the peak angle is indicative of an angular position of the object.

In some embodiments, the system can further include a transmitter operable to transmit a radiofrequency signal whose frequency linearly changes with time within a given bandwidth, the return signal received at the receiver being resultant of the radiofrequency signal being reflected from the object.

In one embodiment, a system implementing a third solution process includes a receiver operable to receive a return signal reflected from an object, the receiver including a plurality of virtual antennae; and a processor in communication with the receiver and a memory, the memory including instructions executable by the processor to:
determine, at the processor and by a range and angle estimation process, an angle of arrival of the return signal, the angle of arrival being indicative of an angular position of the object;
iteratively determine, based on an initial value of the angle of arrival of the return signal, an index error and an updated peak frequency for each respective virtual antenna;
iteratively generate an updated set of complex angle data at each updated peak frequency;
iteratively apply a Fourier Transform operation to the updated set of complex angle data to yield a set of updated transformed angle data; and
iteratively determine one or more peak values and a peak angle for each respective peak value from the set of updated transformed angle data, wherein the peak angle is indicative of an angular position of the object.

In some embodiments, the memory further includes instructions executable by the processor to apply an angle correction function to the angle of arrival yielding a corrected angle of arrival, the angle correction function being a polynomial and including a plurality of correction coefficients, wherein the processor is operable to determine the plurality of correction coefficients through iterative fitting of the angle correction function to one or more candidate angles of arrival to determine an optimal set of correction parameters of the angle correction function.

The plurality of correction coefficients can be determined through at least one of:
simulation of a system model corresponding with a hardware of the receiver;
post-production characterization of an error profile obtained using one or more calibration objects; and/or
iterative fitting of the angle correction function to the one or more candidate angles of arrival to determine the optimal set of correction parameters of the angle correction function.

In some embodiments, the memory further includes executable by the processor to apply the range and angle estimation process including:
access a set of signal data indicative of the return signal;
apply a calibration process to the set of signal data yielding a set of calibrated data, the calibration process including a set of saved calibration coefficients that, when applied to the set of signal data, result in the set of calibrated data;
apply a first Fourier Transform operation to the set of calibrated data to yield a set of transformed data by frequency;
determine, based on the set of transformed data, a peak frequency of the return signal;
determine, based on the peak frequency of the return signal, a range of the object that reflected the return signal;
generate a set of complex angle data at the peak frequency;
apply a second Fourier Transform operation to the set of complex angle data to yield a set of transformed angle data; and
determine one or more peak values and an associated peak angle for each respective peak value from the set of transformed angle data, wherein the peak angle is indicative of an angular position of the object.

In some embodiments, the system can further include a transmitter operable to transmit a radiofrequency signal whose frequency linearly changes with time within a given bandwidth, the return signal received at the receiver being resultant of the radiofrequency signal being reflected from the object.

In one embodiment, a system implementing a second solution process includes a receiver operable to receive a return signal reflected from an object, the receiver including a plurality of virtual antennae; and a processor in communication with the receiver and a memory, the memory including instructions executable by the processor to:
access a set of signal data indicative of the return signal;
apply a calibration process to the set of signal data yielding a set of calibrated data, the calibration process including a set of saved calibration coefficients that, when applied to the set of signal data, result in the set of calibrated data;
apply a first Fourier Transform operation to the set of calibrated data to yield a set of transformed data by frequency;
determine, based on the set of transformed data, an average peak value and an average peak frequency associated with the average peak value;
identify, based on the transformed data, a set of individual peak values and a set of individual peak frequencies for each respective virtual antenna of the plurality of virtual antennae within a predetermined bin range of the average peak frequency; and
identify one or more final peak values and one or more final peak angles based on the set of individual peak values, wherein a final peak angle is indicative of an angular position of the object.

In some embodiments, the memory further includes executable by the processor to determine the angle of arrival, including:
apply a second Fourier Transform operation to the set of individual peak values and the set of individual peak frequencies for each respective virtual antenna of the plurality of virtual antennae to yield a set of transformed angle data; and
determine the one or more final peak values and the one or more final peak angles for each respective final peak value from the set of transformed angle data, each final peak value of the one or more final peak values corresponding with a virtual antenna of the plurality of virtual antennae.

In some embodiments, a method includes: accessing, by a receiver including a plurality of virtual antennae, a return signal reflected from an object; determining, by a processor in communication with the receiver and a memory, and by a range and angle estimation process, an angle of arrival of the return signal, the angle of arrival being indicative of an angular position of the object; and applying, by the processor, an angle correction function to the angle of arrival yielding a corrected angle of arrival, the angle correction function being a polynomial and including a plurality of correction coefficients, the processor being operable to determine the plurality of correction coefficients through at least one of: simulation of a system model corresponding with a hardware of the receiver; post-production characterization of an error profile obtained using one or more calibration objects; and/or iterative fitting of the angle correction function to one or more candidate angles of arrival to determine an optimal set of correction parameters of the angle correction function.

The angle of arrival can be one of a plurality of candidate angles of arrival, and the method can further include: determining, based on an initial value of the angle of arrival of the return signal, an index error and an updated peak frequency for each respective virtual antenna; generating an updated set of complex angle data at each updated peak frequency; and applying a second Fourier Transform operation to the updated set of complex angle data to yield a set of updated transformed angle data.

The range and angle estimation process can further include:
receiving, at the plurality of virtual antennae, a set of signal data indicative of the return signal;
applying a calibration process to the set of signal data yielding a set of calibrated data, the calibration process including a set of saved calibration coefficients that, when applied to the set of signal data, result in the set of calibrated data;
applying a first Fourier Transform operation to the set of calibrated data to yield a set of transformed data by frequency;
determining, based on the set of transformed data, a peak frequency of the return signal;
determining, based on the peak frequency of the return signal, a range of the object that reflected the return signal;
generating a set of complex angle data at the peak frequency;
applying a second Fourier Transform operation to the set of complex angle data to yield a set of transformed angle data; and
determining one or more peak values and a peak angle for each respective peak value from the set of transformed angle data, wherein the peak angle is indicative of an angular position of the object.

The method can further include: transmitting, by a transmitter, a radiofrequency signal whose frequency linearly changes with time within a given bandwidth; the return signal received at the receiver being resultant of the radiofrequency signal being reflected from the object.

In another aspect, a method can include: accessing, at a processor in communication with a memory and from a receiver including a plurality of virtual antennae, a set of signal data indicative of a return signal reflected from an object; applying a calibration process to the set of signal data yielding a set of calibrated data, the calibration process including a set of saved calibration coefficients that, when applied to the set of signal data, result in the set of calibrated data; applying a first Fourier Transform operation to the set of calibrated data to yield a set of transformed data by frequency; determining, based on the set of transformed data, an average peak value and an average peak frequency associated with the average peak value; identifying, based on the transformed data, a set of individual peak values and a set of individual peak frequencies for each respective virtual antenna of the plurality of virtual antennae within a predetermined bin range of the average peak frequency; and identifying one or more final peak values and one or more final peak angles based on the set of individual peak values, the one or more final peak angles being indicative of an angular position of the object.

The method can further include determining the angle of arrival by: applying a second Fourier Transform operation to the set of individual peak values and the set of individual peak frequencies for each respective virtual antenna of the plurality of virtual antennae to yield a set of transformed angle data; and determining the one or more final peak values and the one or more final peak angles for each respective final peak value from the set of transformed angle data, each final peak value of the one or more final peak values corresponding with a virtual antenna of the plurality of virtual antennae.

The method can further include: transmitting, by a transmitter, a radiofrequency signal whose frequency linearly changes with time within a given bandwidth, the return signal received at the receiver being resultant of the radiofrequency signal being reflected from the object.

### BRIEF DESCRIPTION OF THE DRAWINGS

FIGS. 1A and 1B are a pair of graphical representations showing frequency-modulated continuous-wave (FMCW) radar operation for multiple objects in the field of view;

FIG. 2 is a simplified block diagram showing a conventional FMCW radar system;

FIG. 3 is a simplified graphical representation showing angle estimation of an object based on differences in intermediate frequency signals by the conventional FMCW radar system of FIG. 2;

FIG. 4 is a simplified diagram showing determination of calibration coefficients to suppress hardware mismatch;

FIG. 5 is a simplified process flow diagram showing a typical range and angle estimation process;

FIG. 6 is a simplified diagram showing a radar system for implementation of various angle correction processes described herein;

FIGS. 7A and 7B are a pair of graphical representations showing simulation results for angle estimation that were used for derivation of the system of FIG. 6, where FIG. 7A does not include additive noise and mismatches and FIG. 7B does;

FIG. 8 is a simplified process flow diagram showing a first solution process for implementation by the system of FIG. 6 using Mathematical Correction;

FIG. 9 is a simplified process flow diagram showing a second solution process for implementation by the system of FIG. 6 using Non-Iterative Refinement;

FIG. 10 is a simplified process flow diagram showing a third solution process for implementation by the system of FIG. 6 using Iterative Refinement;

FIG. 11 is a simplified process flow diagram showing a fourth solution process for implementation by the system of FIG. 6 using a combination of Mathematical Correction and Iterative Refinement;

FIGS. 12A-12D are a series of graphical representations showing experimental results with and without the first solution process of FIG. 8, where FIGS. 12A and 12B show park experiments where an object is located at 3 m,

FIG. 12C shows a park experiment where the object is located at 2 m, and FIG. 12D shows an anechoic chamber experiment where the object is located at 4 m;

FIGS. 13A-13D are a series of graphical representations showing experimental results with and without the second solution process of FIG. 9, where FIGS. 13A and 13B show park experiments where an object is located at 3 m, FIG. 13C shows a park experiment where the object is located at 2 m, and FIG. 13D shows an anechoic chamber experiment where the object is located at 4 m;

FIGS. 14A-14D are a series of graphical representations showing experimental results with and without the third solution process of FIG. 10, where FIGS. 14A and 14B show park experiments where an object is located at 3 m, FIG. 14C shows a park experiment where the object is located at 2 m, and FIG. 14D shows an anechoic chamber experiment where the object is located at 4 m;

FIGS. 15A-15D are a series of graphical representations showing experimental results with and without the fourth solution process of FIG. 11, where FIGS. 15A and 15B show park experiments where an object is located at 3 m, FIG. 15C shows a park experiment where the object is located at 2 m, and FIG. 15D shows an anechoic chamber experiment where the object is located at 4 m; and

FIG. 16 is a simplified diagram showing an example computing device for implementation of the system of FIG. 6.

Corresponding reference characters indicate corresponding elements among the view of the drawings. The headings used in the figures do not limit the scope of the claims.

### DETAILED DESCRIPTION

### 1. Introduction

Radar systems transmit a signal in the form of electromagnetic waves through the air and objects in the aperture reflect the signal. The reflected signal is captured by the radar to find the position, angle, and velocity of each object. Millimeter-wave (mmWave) radar is a subclass of radar systems that uses millimeter waves to operate. The main advantage of mmWave radars is the wavelength of the signal is relatively small compared to the electromagnetic spectrum, which enables the use of smaller antennas.

To specify the position of the object relative to the radar, the object's range R, azimuth angle θ, and elevation angle φ should be determined. To estimate the object position, a mm-wave signal with changing frequency is emitted. The signal is reflected from the object and is received by the same device. The difference in frequency between the currently emitted wave and the return wave depends on the time it takes for the signal to reflect back. Thus, by measuring this frequency difference, the range of the object can be determined. To do so, the return signal is mixed with the currently transmitted signal and Fast Fourier Transform (FFT) of the resulting signal is calculated. This process is called “range FFT”. For multiple antenna systems, the range FFT can be taken for each transmit and receive antenna, yielding multiple range FFT results. To increase the accuracy, these results are averaged. Angle estimation makes use of the slight phase differences between different antenna paths. The systematic error in the calculation steps is accumulated through angle estimation. A system and associated methods described herein aims at correcting systemic errors in the angle estimation process.

The system described herein is focused on frequency-modulated continuous-wave (FMCW) radar technology. In FMCW radars, the frequency of the transmitted signal is increased linearly. This is called a linear chirp. A transmitter (TX) of a radar system transmits linear chirp continuously. Then, the electromagnetic signal travels through the air. The signal is reflected by the objects. A receiver (RX) of the radar system captures the reflected signal. The transmitted signal and the received signal are combined at the radar system by a mixer, which is a component that multiplies two signals. The mixed signal is then sampled and converted to the digital values. In a multiple antenna system with N transmitters and

M receivers, this operation can be repeated N×M times. Typically, in a multi-antenna system, one transmitter is activated at a given time while all receivers are active simultaneously. A virtual antenna array is constructed using the positions of transmitters and receivers, each combination of transmitter and receiver is an element in this virtual array. Mixing each received signal with each transmitted signal generates a virtual array of intermediate frequency (IF) signals. Transmitters and receivers are placed in hardware of the radar system such that the virtual elements (transmitter-receiver pairs) are spaced equally, which generates equal phase differences between the virtual array signals. Taking one virtual IF signal element as reference, a phase offset can be defined for all other elements based on the objects relative angle with respect to the radar system. When all the elements are placed with respect to the reference TX-RX pair, some of them can overlap. That means the effective number of elements in the virtual array becomes fewer than N×M For example, in a Texas Instruments cascaded radar device, there are AWR2243 mmWave radar sensors, each of which includes 3 transmitters and 4 receivers, totaling 12 transmitters and 16 receivers for the entire device. 12 of the of the receivers are used in the same horizon which means they are used in azimuth angle estimations. Considering only the azimuth, there are 144 virtual elements. However, only 86 unique, i.e., non-overlapping elements exist. For range and angle estimation, it is assumed that the range and the angle of the object with respect to the radar does not change beyond the range or angle resolution throughout the measurement period, which can be several hundred microseconds.

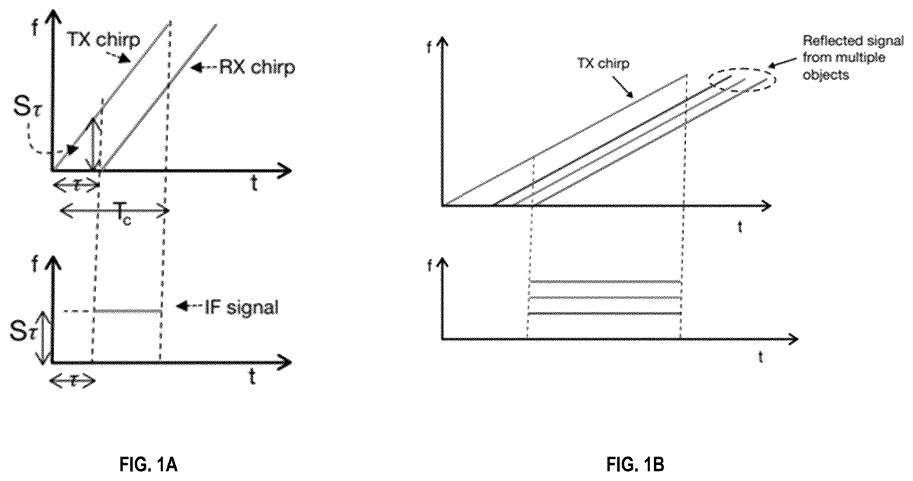

In a more general application, there can be multiple objects in the radar's field of view (FOV). The same radar operation can be applied even if there are multiple objects with difference ranges and angles. FIG. 1A illustrates time-dependent frequency of one transmit chirp signal with a chirp slope of S, along with the received signal from the reflection of the object, where τ represents the time it takes for the signal to reflect back from the object. The IF signal frequency resulting from mixing the transmit chirp signal with the received signal is also shown. If there are multiple objects in the radar's FOV, they generate different IF frequencies as shown in FIGS. 1A and 1B. These frequencies can be distinguished using frequency domain analysis via Fast Fourier Transform (FFT). This operation is often called rangeFFT. When the object is not perpendicular to the radar's axis (object at boresight, i.e. at 0°), there are slight differences in the distance between each virtual antenna pair. These differences are not large enough to resolve with range FFT, but they result in different phases for the IF signal. By analyzing the phase differences across virtual antenna pairs, the angle of the object can also be determined.

### A. Mathematical Modeling of the FMCW Radar

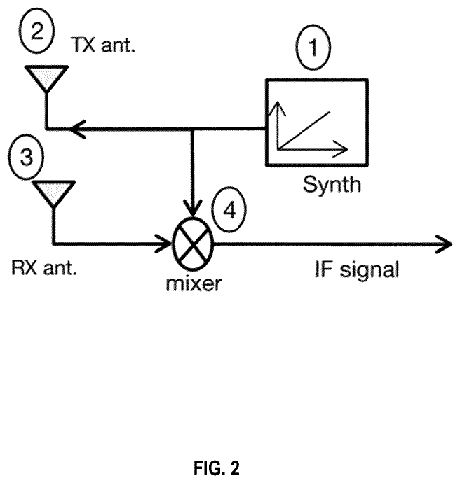

An overall architecture of an example FMCW radar system is given in FIG. 2. The synthesizer generates a linear chirp at mmWave frequencies. The generated chirp is transmitted by the TX.

The generated chirp signal can be expressed as:

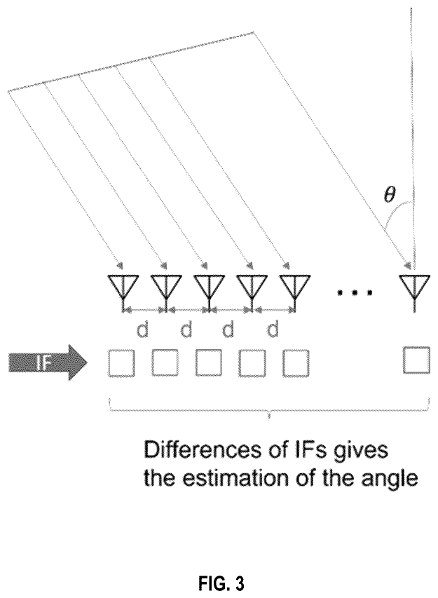

x_tx(t)=A cos(μ(t)) (1)

where μ(t) is the instantaneous phase, given as:

$$μ ( t ) = 2 π {\int }_{0}^{t} f ( t ) dt + {μ}_{0} = 2 π ( {f}_{c} t + \frac{α {t}^{2}}{2} + {μ}_{0} ) \qquad ( 2 )$$

where f(t) is equal to f_{c}+αt and α is the slope of the linear chirp. The received signal is attenuated over the air and reflected by an object. Thus, the received signal is the time-delayed and attenuated version of the transmitted signal. The time delay is defined as

$$τ = \frac{2 ( R + vd sin θ )}{c}$$

where R, v, d, θ, and c are the object's distance to the radar, virtual antenna number, virtual antenna distance from each other and speed of light respectively. The d and θ are shown in FIG. 3. The total traveling time is related twice to R because the reflected signal travels that distance twice. Thus, the received signal can be expressed as follows:

xᵣₓ(t)=B cos(μ(t−τ)) (3)

After mixing the transmit and received signals, the IF signal can be expressed as follows:

xₘ(t)=A cos(μ(t))*B cos(μ(t−τ)+j*A sin(μ(t))*B cos(μ(t−τ)) (4)

Using trigonometric sum and difference formulas, Equation 4 can be extended to obtain sum μ(t))+μ(t−τ) and difference μ(t))−μ(t−τ) terms. The sum term's frequency is twice the center frequency (f_{c}) so, this term is filtered out using a low pass filter. The difference term can be simplified as in Equation 5 and the final IF signal is given in Equation 6 where 2πατ is the frequency term and 2πf_{c}τ−πατ² is the constant phase term.

$$μ ( t ) ) - μ ( t - τ ) = 2 πατ t + 2 π {f}_{{c}^{τ}} - {πατ}^{2} \qquad ( 5 )$$

$${x}_{m} ( t ) = \frac{A B}{2} {e}^{i * ( μ ( t ) ) - μ ( t - τ ) )} \qquad ( 6 )$$

The exponent part of the IF signal, xₘ(t), can be analyzed in terms of frequency and phase terms. These terms depend on the time taken for the signal to reflect from the object, τ, which is given in Equation 7. The phase and frequency terms of the IF signal for each virtual antenna are given in Equations 8 and 9.

$$τ = \frac{2 ( R + velocity * t )}{c} \vec{f or stationary objects} \frac{2 R}{c} \qquad ( 7 )$$

$$Frequency Term : 2 π [ α ( \frac{2 R + vd sin θ}{c} ) ] = \frac{2 πα}{c} [ 2 R + vd sin θ ] \qquad ( 8 )$$

$$Phase Term : 2 π {f}_{c} ( \frac{2 R + vd sin θ}{c} ) - {πα ( \frac{2 R + vd sin θ}{c} )}^{2} = \frac{4 π {f}_{c} R}{c} + \frac{2 π {f}_{c} vd sin θ}{c} = \frac{2 π {f}_{c}}{c} [ 2 R + vd sin θ ]$$

In the frequency term (Eqn. 8), the second part is ignored because R>>d sin θ. Hence,

$$R = \frac{c \cdot {f}_{m}}{4 π α} ,$$

where fₘ is the frequency of the mixed signal, xₘ(t). In the phase term (Eqn. 8), 2R is common to all virtual antenna pairs. Taking the phase difference of signals between a reference virtual antenna and any other virtual antenna yields the second term in Eqn. 9. Thus, the angle of the object can be estimated by using this information.

### B. Calibration

There are mismatches between antenna pairs due to differences in internal hardware elements, such as path lengths, thickness and width differences, or mismatches in transistors. It is essential to eliminate mismatches for better performance. These mismatches are calibrated post-production where an object, typically a corner reflector, is placed at boresight (θ=0°) of the radar at a known distance. xₘ(t) for an object located at θ=0° should be same for all virtual antenna pairs. In other words, if the complex signal, xₘᵥ(t) of the virtual antenna v is divided by complex signal, xₘ₁(t), of the reference virtual antenna (v=1), the result should be 1. Calibration involves determining complex coefficients, Cᵥ, for each virtual antenna such that

$$\frac{{x}_{m v} ( t )}{{x}_{m 1} ( t )} = 1 .$$

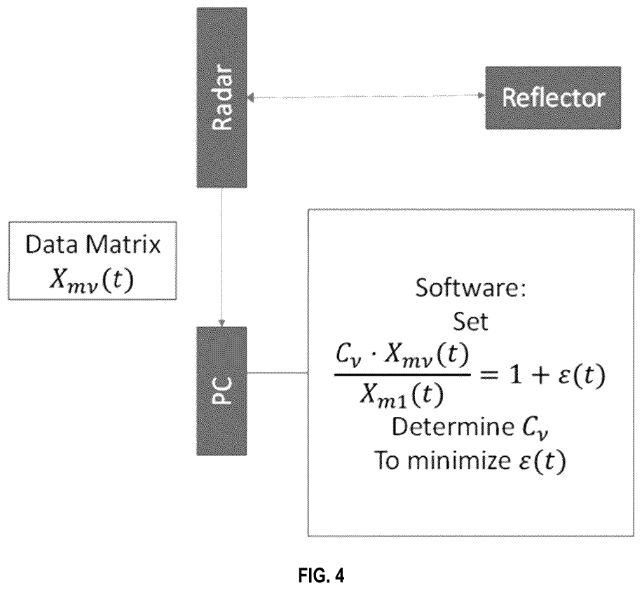

Due to noise, calibration coefficients, Cᵥ, are estimated to get as as close to this equality as possible for all collected samples. In FIG. 4, the calibration setup is shown. Calibration should be conducted in a controlled environment such as an anechoic chamber. It should be noted that the calibration parameters are complex which includes phase and frequency components. Once calibration coefficients, Cᵥ, are determined in the controlled environment, they are saved in memory of the device and used in the field for all objects.

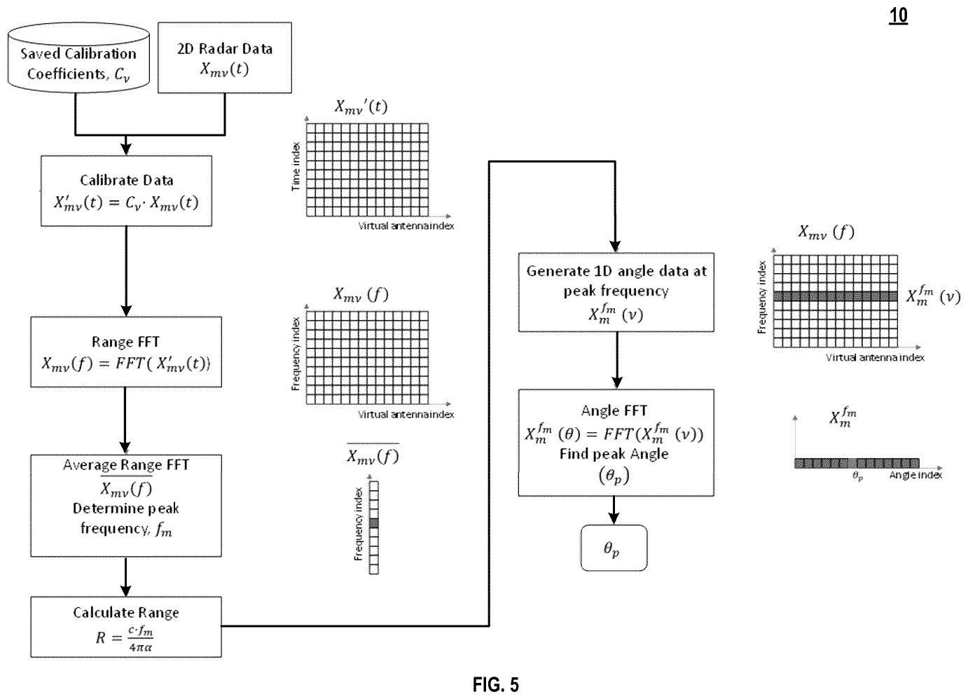

FIG. 5 shows a flow diagram of a typical range and angle estimation process 10. The typical range and angle estimation process 10 is as follows. The transmitter first transmits a radiofrequency signal whose frequency linearly changes with time within a given bandwidth. The receiver then receives a return signal reflected from an object, the receiver including a plurality of virtual antennae. Raw data is collected at a computing device in the form of the return signal, including those received at each virtual antenna. The collected data is calibrated as described in the calibration section above. This includes preliminarily determining, by a range and angle estimation process, an angle of arrival of the return signal, the angle of arrival being indicative of an angular position of the object. The range and angle estimation process can include: receiving, at the plurality of virtual antennae, a set of signal data indicative of the return signal and applying a calibration process to the set of signal data yielding a set of calibrated data. The calibration process can include applying a set of saved calibration coefficients to the set of signal data that result in the set of calibrated data. All non-overlapping calibrated time series data of virtual antennas are prepared. For example, in TI radar device with four AWR2243 sensors, there are 86 unique virtual antennas, the ADC sample size is 256.

After obtaining a 2D radar data matrix, the range and angle estimation process includes calculating a range FFT, which can be done for each virtual antenna. This step includes applying a first Fourier Transform operation to the set of calibrated data to yield a set of transformed data by frequency. The range and angle estimation process can further include determining, based on the set of transformed data, a peak frequency of the return signal and then determining, based on the peak frequency of the return signal, a range of the object that reflected the return signal. To suppress the effects of environment noise, results from all the virtual antennas can be averaged, which yields an average range FFT index for the object. To determine the angle, the complex values corresponding to the range FFT index for each virtual antenna are taken for a second FFT operation. As such, the range and angle estimation process can further include generating a set of complex angle data at the peak frequency, applying a second Fourier Transform operation to the set of complex angle data to yield a set of transformed angle data, and determine one or more peak values and a peak angle for each respective peak value from the set of transformed angle data, where the peak angle is indicative of an angular position of the object. In the angle estimation step, phase difference between the virtual antennas is found and converted into the angle of arrival of the reflected radar signal.

### 2. Improving Angle Estimation in mm-Wave Radars

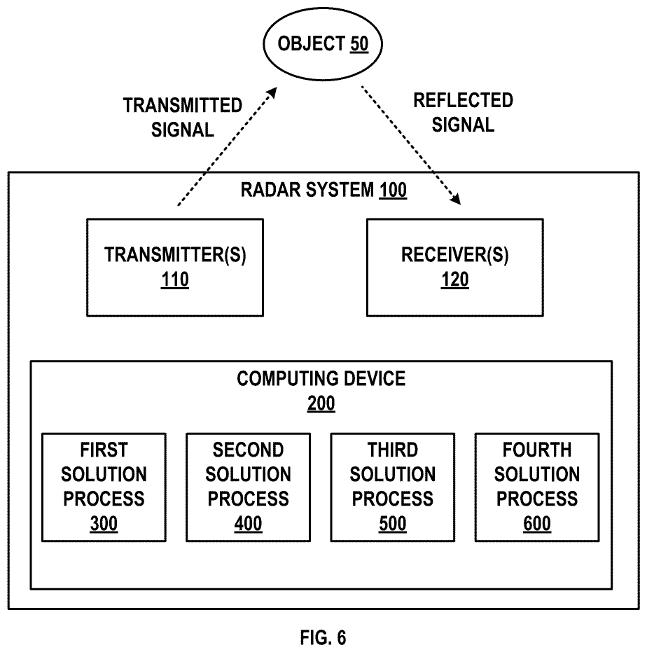

FIG. 6 provides a simplified diagram of an example radar system 100 that includes one or more transmitters 110, one or more receivers 120, and a computing device 200 in communication with the one or more transmitters 110 and the one or more receivers 120 that implements at least one of a first solution process 300, a second solution process 400, a third solution process 500 and/or a fourth solution process 600 described herein. The system 100 reduce errors in angle estimation by adding an angle correction step to the above-explained process.

In some cases, the ignored term in Eqn. 8 can be large or influential enough to change the actual range bin in the FFT. For each virtual antenna, this results in objects being located at a slightly different range than the average. This error is small for range estimation and can be ignored safely in objects' range calculations. The angle estimation is calculated using the fact that small range differences cause large phase differences. Selecting the correct frequency bin for each virtual antenna for a given object is crucial. The range differences are larger when the object is at a larger angle. These range differences can lead to a shift in the range for some of the virtual antennas. This process is called range migration. If the same frequency bin (average range FFT index) for each virtual antenna is used, the wrong bin element is selected for angle estimation. Range migration only occurs when the second part of the frequency term is capable of changing the range bin. This happens at higher range resolutions and higher object angles.

### A. Analysis of the Error Term

Since the second term in Equation 8 is effectively ignored by taking the average range bin index for all virtual antennas, the second term in Equation 8 generates an error. The present disclosure first analyzes this term and describes solutions that can be implemented by the system 100 to remove or suppress this error term. The error term is given in Equation 10.

$$Error term : \frac{avd sin θ}{c} \qquad ( 10 )$$

In the error term of Eq. 10, there are several important observations. The error term increases with v and θ. That is, the error terms become larger when the spatial location of the antenna and object's angle increases. Spatial virtual antenna location is numbered using a reference virtual antenna. It can be considered that two virtual antennas' error term differences are increased when spatial distance between them increases. One interesting fact about the error term is that it does not depend on the object's range. Range migration occurs when the error term exceeds the bin resolution for range FFT. This resolution is given in Equation 11, where B is the chirp bandwidth, and is given in Equation 12.

$${d}_{r e s} = \frac{c}{2 B} \qquad ( 11 )$$

$$B = α {T}_{c} \qquad ( 12 )$$

In Equations 11 and 12, c, B, α and T_{c} are speed of light, chirp bandwidth, chirp slope, and chirp time interval respectively. The frequency term is multiplied by T_{c} to find FFT index bin. Thus, index error term becomes αvd sin θT_{c}/c Combining this, with Equations 10-12, one can determine that

$$\frac{1}{2 {d}_{res}} = \frac{α {T}_{c}}{c} .$$

Thus, the index error term, ε_{index}, is given by the following equation.

$${ε}_{index} = \frac{vd sin θ}{2 {d}_{r e s}} \qquad ( 13 )$$

RMS error for uniformly distributed random variables with 1 unit bin size is

$$\\ \frac{1}{\sqrt{12}} \approx 0.3 .$$

The ε_{index} should be lower than 0.9 to reduce the likelihood of range migration. Key observation from the ε_{index} is that range migration is highly unlikely when coarser range resolution (higher dᵣₑₛ) is used. That is using higher range resolution (lower dᵣₑₛ) increases the likelihood of range migration.

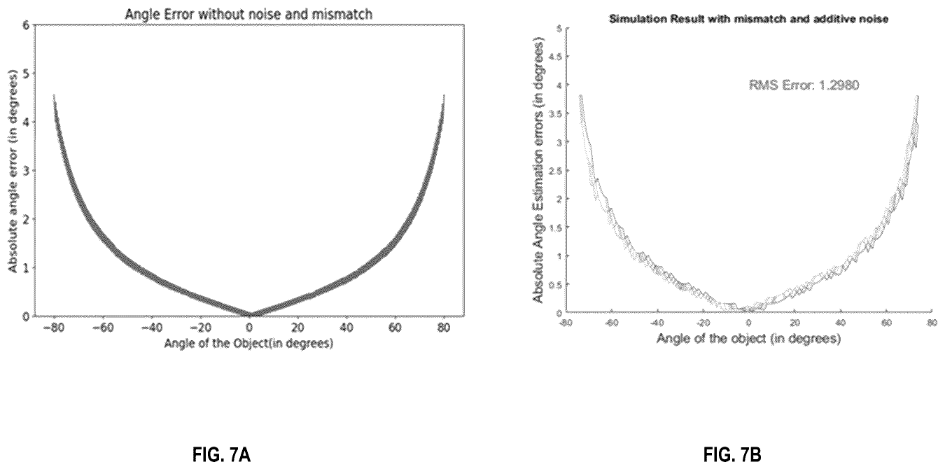

In the baseline approach, the radar is only calibrated at boresight. Due to range migration, the error in angle estimation increases when the object is at higher angles with respect to the radar. This pattern is also shows in simulation. Simulations were conducted both with and without mismatch and additive noise. Even in the ideal case that has no mismatch and no additive noise, there is a systematic error pattern in the angle estimation, which is due to range migration. This supports the mathematical derivations. In FIGS. 7A and 7B, absolute angle error shows a non-linear characteristic, which can be modeled with a second or higher order polynomial or using other basis functions, such as sinusoidal. The error increases as the object's angle relative to the radar increases. The error term in Equation 10 increases while the object's angle increases and, this causes more range migration.

### B. Solutions for Angle Estimation Error Improvement

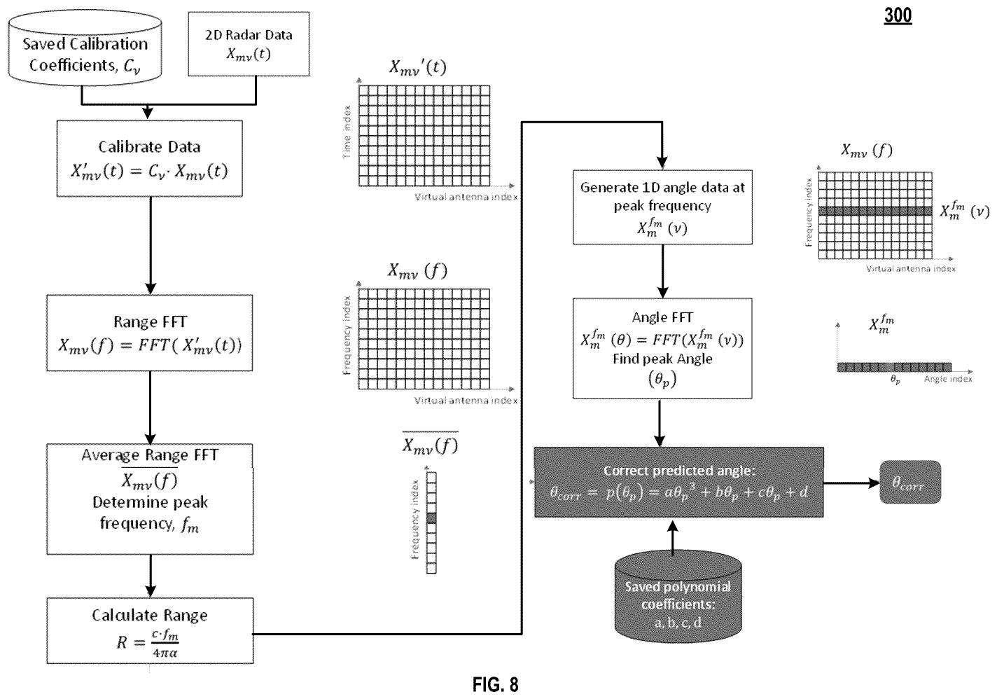

In the previous sections, it is clearly seen that the angle error is affected by range migration. To overcome this systematic error, 4 solutions are provided in the form of processes respectively shown in FIGS. 8-11 for implementation by the system 100 with varying levels of computational overhead. These solutions insert one or more steps following an initial angle estimation procedure outlined above with respect to FIG. 5.

### i. Correction Based on Non-Linear Modeling

With reference to FIG. 8, the first solution process 300 that can be implemented by the system 100 after calibration is Correction. Due to systemic nature of the angle error, the angle error can be eliminated by modeling the error using basis functions (polynomial, sinusoidal) and using this model to correct for error after the angle is estimated through the baseline approach outlined above with respect to FIG. 5. It has been observed that using a 3^{rd} degree polynomial for the error model produces the best results at very low computational overhead. The polynomial model parameters (e.g., coefficients a, b, c, d) are determined through system simulations or hardware measurements during the calibration phase.

a. Correction Through Simulation: Mathematical model coefficients, (e.g., the coefficients of the 3^{rd} order polynomial) can be found using simulations with a system model that matches the hardware that needs to be corrected. In this case, all hardware components use the same correction coefficients. There is no need for extra hardware data collection for each radar board to model the system. Thus, this solution represents with the lowest overhead in terms of post-production testing. Following the range and angle estimation process discussed above with respect to FIG. 5, the computing device 200 can apply an angle correction function to the angle of arrival yielding a corrected angle of arrival, the angle correction function being a polynomial and including a plurality of correction coefficients. For Correction Through Simulation, the angle correction function can include simulation of a system model corresponding with a hardware of the receiver.

b. Correction Through Hardware Measurements: Model coefficients can also be obtained through post-production characterization of an error profile obtained using one or more calibration objects. During characterization, a calibration object is placed at multiple locations to obtain the error profile. Alternatively, multiple objects can be used in one step to obtain the error profile. The model coefficients are calculated from the error profile. This correction mechanism determines individual coefficients for each radar. Alternatively, a common set of coefficients can be determined from a set of sample devices and can be used for all products.

The Correction procedure is as follows:
1. Estimate angle, θ, of the object(s) using the baseline approach (e.g., by the range and angle estimation process discussed above with respect to FIG. 5).
2. Determine the corrected angle θ_{corr} using polynomial function having a set of correction coefficients in following equation:

θ_{corr}=p(θ)=aθ³+bθ²+cθ+d (14)

Coefficients of the polynomial, a, b, c & d are determined by simulation or hardware measurements. One should notice that each simulation uses a set of settings. These settings effect the characteristics of the system. That is when range resolution changes, FIG. 7A and 7B also change. The pattern stays the same, but the effect is decreased. For example, the error for an object at 60° can range from 2.5° to 1.5° depending on range resolution. Thus, every device setting requires their respective correction parameters that are found via their matching simulation/hardware measurements.

To summarize the first solution process 300, until the final step, the angle estimation process can be the as the typical range and angle estimation process 10 shown in FIG. 5. However, as shown in FIG. 8, following the angle estimation step, the computing device 200 can apply an angle correction function to the angle of arrival that finalizes the angle estimation and eliminate error regarding the range index migration effect. The angle correction function can be a polynomial and can include a plurality of correction coefficients. Correction coefficients can be found in various ways. In the first solution process 300, the correction coefficients can be found by: simulation of the system model corresponding with hardware of the receiver; and/or through post-production characterization of an error profile obtained using one or more calibration objects.

### ii. Non-Iterative Refinement

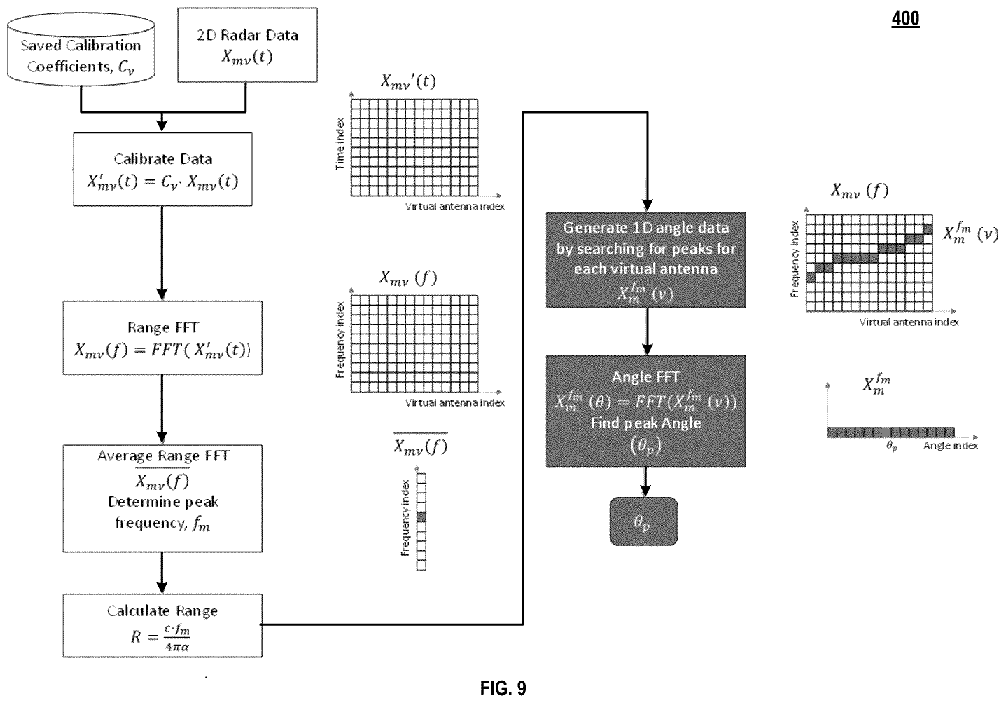

The second solution process 400 that can be implemented by the system 100 is shown in FIG. 9. The root cause of the error is range index migration through the virtual antennas. After the average FFT index is found for the object as in the range and angle estimation process of FIG. 5 following the step of applying a first Fourier Transform operation to the set of calibrated data to yield a set of transformed data by frequency, the peak index for each virtual antenna around the average FFT index can be found. The search region is typically selected using antenna configurations because range resolution affects range migration. For higher range resolution configurations, higher search spaces are used to find the correct peak. For instance, if range migration can occur up to 5 bins the search space is [x−5, x+5], where x is the average FFT index. The local peak for each antenna can be shifted slightly due to system noise and measurement noise. Thus, consecutive virtual antennas can have different peak locations. This effect is also exaggerated toward the 90° angles of the object relative to the radar because, when the object's absolute angle increases, the error index also increases as shown in Equation 13. As such, the computing device 200 implementing the second solution process 400 can determine, based on the set of transformed data, an average peak value and an average peak frequency associated with the average peak value. Following this step, the computing device 200 can identify, based on the transformed data, a set of individual peak values and a set of individual peak frequencies for each respective virtual antenna of the plurality of virtual antennae within a predetermined bin range of the average peak frequency. After selecting correct peak indexes for each virtual antenna, angle of the object can be estimated using the FFT of the complex array that is collected from the refined peaks of each virtual antenna. In other words, the computing device 200 can identify one or more final peak values and one or more final peak angles based on the set of individual peak values, wherein the final peak angle is indicative of an angular position of the object. This step involves applying a second Fourier Transform operation to the set of individual peak values and the individual peak frequencies for each respective virtual antenna of the plurality of virtual antennae to yield a set of transformed angle data. Based on the set of transformed angle data, the computing device can determine one or more final peak values and one or more final peak angles for each respective final peak value from the set of transformed angle data, each final peak value of the one or more final peak values corresponding with a virtual antenna of the plurality of virtual antennae. A refinement procedure in this solution does not require prior knowledge of the object's angle estimate. Thus, it is a one-step solution that inserts a search algorithm into the angle estimation process. This search algorithm can be implemented at low computational cost since the search space is very limited.

### iii. Iterative Refinement

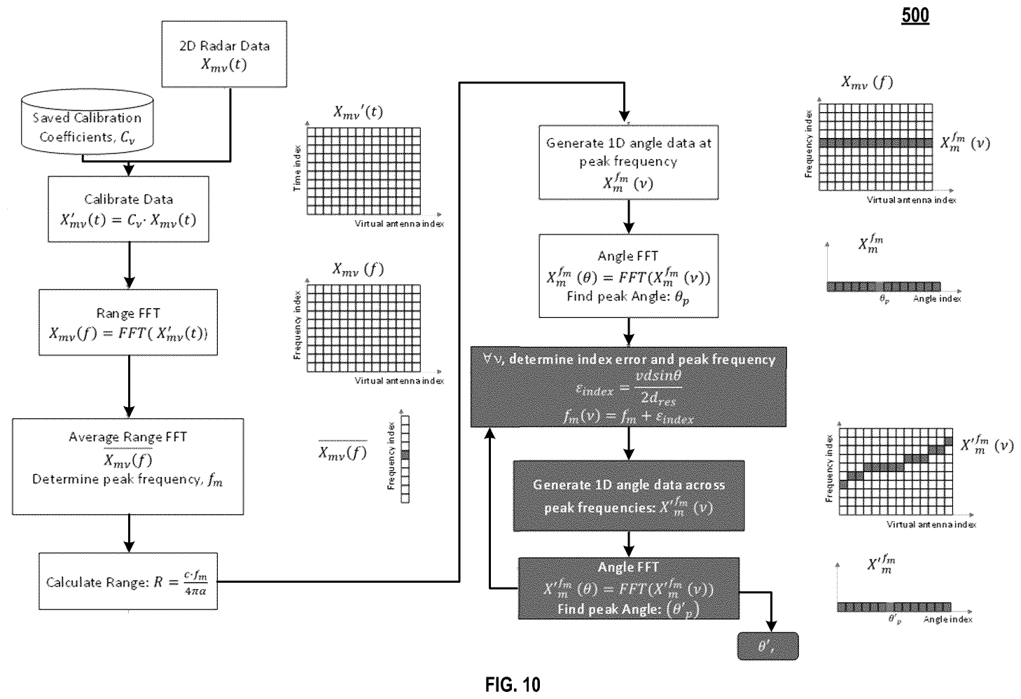

The third solution process 500 that can be implemented by the system 100 is shown in FIG. 10. If the object's angle is known, the system 100 can precisely determine the correct FFT index for each virtual antenna. However, since the goal is to determine the object's angle, it is unknown. This circular dependency can be broken in an iterative manner. The third solution process uses the first result from the range and angle estimation procedure (baseline procedure outlined in FIG. 5) as an initial estimate and determines the correct bins for each virtual antenna. Then, the angle FFT process is repeated using the correct bin entries. If necessary, this estimation/correction process can be iteratively repeated multiple times.

As such, in the third solution process 500, the computing device 200 can determine, by a range and angle estimation process, an (initial) angle of arrival of the return signal, the angle of arrival being indicative of an angular position of the object, up until the step of determining one or more peak values and an associated peak angle for each respective peak value from the set of transformed angle data, wherein the peak angle is indicative of an angular position of the object.

Following initial determination of the initial value of the angle of arrival of the return signal, the computing device 200 can: (a) determine an index error and an updated peak frequency for each respective virtual antenna; (b) generate an updated set of complex angle data at each updated peak frequency; (c) apply a Fourier Transform operation to the updated set of complex angle data to yield a set of updated transformed angle data; and (d) determine one or more peak values and an associated peak angle for each respective peak value from the set of updated transformed angle data, wherein the peak angle is indicative of an angular position of the object. Steps (a)-(d) can be iteratively repeated until a stop criterion is reached.

### iv. Iterative Refinement and Correction

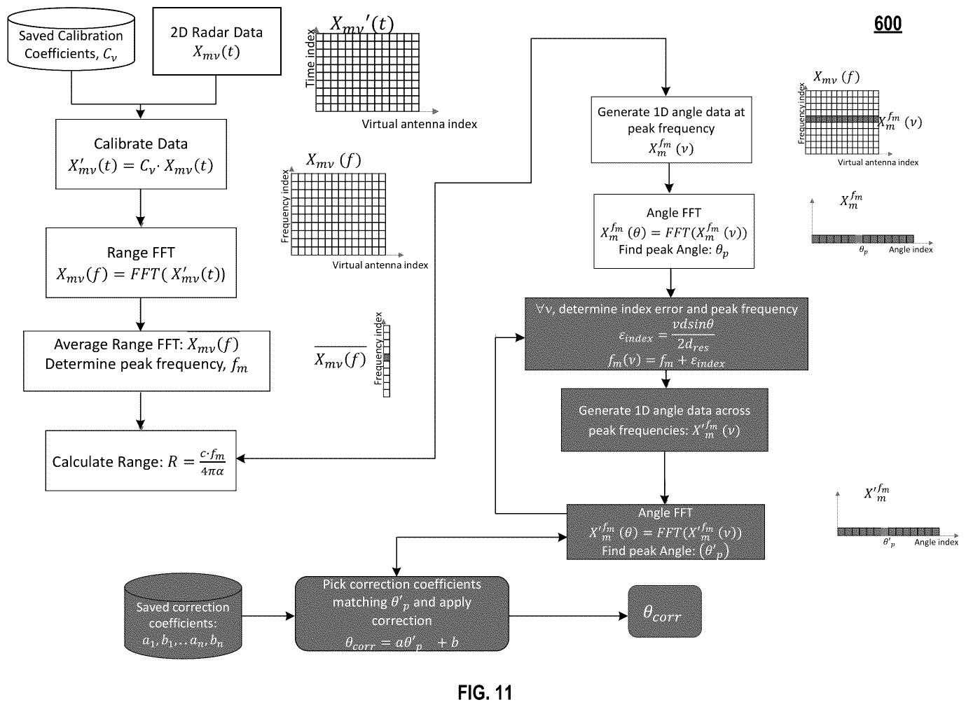

The fourth solution process 600 that can be implemented by the system 100 is shown in FIG. 11. The fourth solution process 600 is a hybrid between the first solution process 300 shown in FIG. 8 and the third solution process 500 shown in FIG. 10 and can be used to remove remaining systemic errors after iterative refinement. These errors can be due to hardware imperfections that could not be corrected in the baseline approach. After collecting data in several angle locations, a piecewise correction function can be fit to eliminate the residual errors.

As such, after determining an (initial) angle of arrival of the return signal by the range and angle estimation process (e.g., as in FIG. 5), the computing device 200 can apply an angle correction function to the angle of arrival yielding a corrected angle of arrival, the angle correction function being a polynomial and including a plurality of correction coefficients. This can involve steps from third solution process 500 outlined above with respect to FIG. 10, where step (d) can be modified similar to first solution process 300 in FIG. 8 in which the peak angle can be found using an angle correction function.

Following initial determination of the initial value of the angle of arrival of the return signal, the computing device 200 can: (a) determine an index error and an updated peak frequency for each respective virtual antenna; (b) generate an updated set of complex angle data at each updated peak frequency; (c) apply a Fourier Transform operation to the updated set of complex angle data to yield a set of updated transformed angle data; and (d) determine one or more peak values and an associated peak angle for each respective peak value from the set of updated transformed angle data, wherein the peak angle is indicative of an angular position of the object. Step (d) can be accomplished through using the angle correction function, where the correction coefficients can be determined through iterative fitting of the angle correction function to one or more candidate angles of arrival to determine an optimal set of correction parameters of the angle correction function. The (corrected) angle of arrival can be selected from the one or more candidate angles of arrival. Steps (a)-(d) can be iteratively repeated until a stop criterion is reached.

Through experiments, it is determined that a piecewise linear correction function performs best as the correction function after iterative refinement. Other functions, such as polynomial, or piecewise polynomial, can also be used. The angle range is divided into 3 parts: [−90, −40], [−40, 40] and [40, 90]. For each part, a first order linear function is used to model the residual errors. Then, for each part, different c and d parameters are determined as shown in Equation 15.

θ_{corr}=p(θ)=cθ+d (15)

### 3. Experiment Results of the Proposed Solutions

A discussion of validation for the four solution processes described above with reference to FIGS. 6 and 8-11 that can be implemented through the system 100 is provided in this section. For all the experiments below, a fine range resolution was used which is 6 cm. To show that the analysis is independent of the object environment, both controllable and uncontrollable environments were used. There is one anechoic chamber experiment which is controlled environment and others are done outside areas, such as public parks and parking lots.

### i. Polynomial Correction

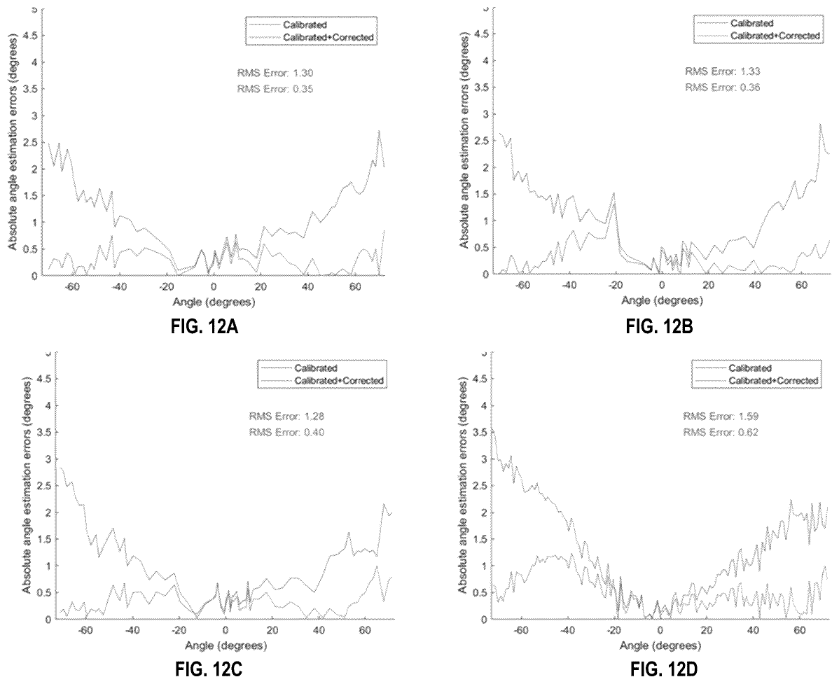

In FIGS. 12A-12D, all the experimental results for the first solution process 300 of FIG. 8 are shown with and polynomial correction. All the experiment data are collected with fine range resolution, which is 6 cm. The correction parameters are calculated from software simulations. The results show that modeling angle estimation error via software simulation is representative of hardware measurements. Both in controlled and uncontrolled environments, the angle estimation accuracy is increased significantly. Without correction, the angle estimation errors have common shape which the error increases towards the 90°. Using polynomial correction, 3-4× reduction in angle estimation error is achieved. Error reduction is greater towards to 90° range. After polynomial correction, root mean squared error becomes less than 0.62°.

### ii. Non-Iterative Refinement

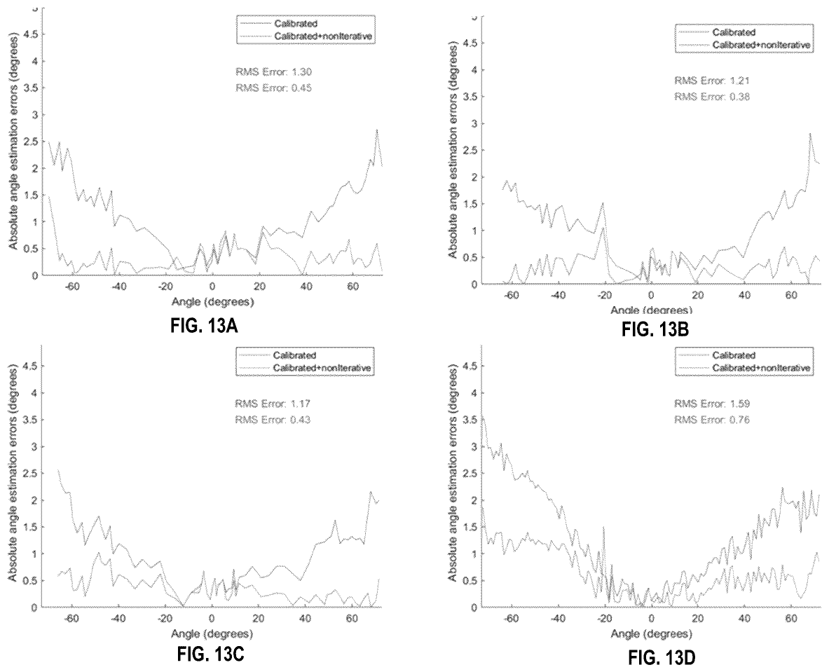

In FIGS. 13A-13D, all the experimental results for the second solution process of FIG. 9 are shown with and without non-Iterative refinement. The experiment data are collected with fine range resolution, which is 6 cm. The range migration effect becomes noticeable outside the [−20°, 20°] region. Thus, selecting the correct range bin for angle estimation has a greater effect towards to 90°. In a controllable environment, which is anechoic chamber for FIG. 13D, there is only one object without other environmental clutters that cause undesired peaks near the object. In uncontrolled environments (FIGS. 13A-13C), environmental clutter can cause selecting the wrong peak, leading to slightly higher error. Thus, in these environments, while improvements are achieved towards the 90°, there is small degradation in accuracy in the area closer to the boresight. Overall, we observe that the MSE error has reduced 2-3× for this process.

### iii. Iterative Refinement

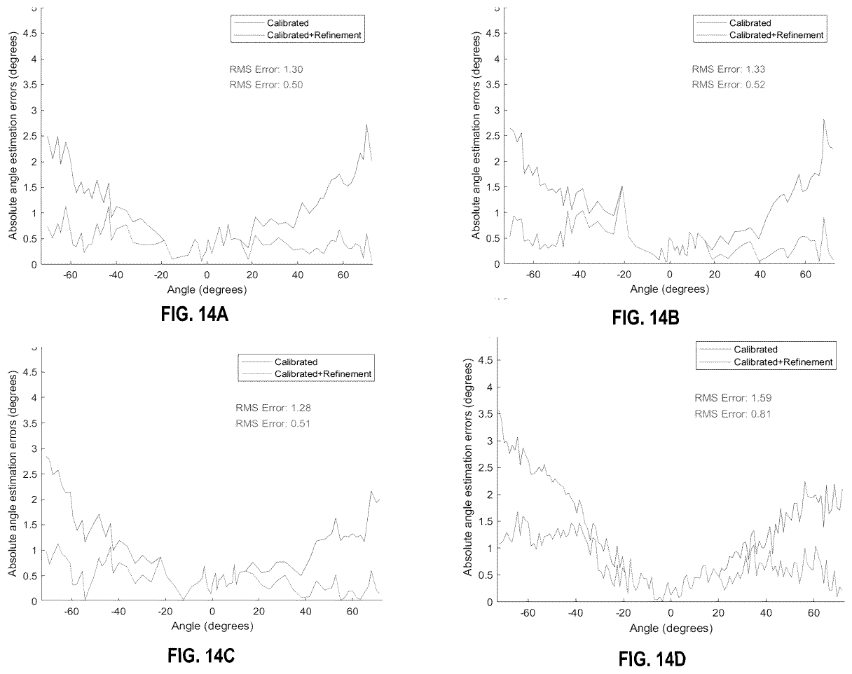

In FIGS. 14A-14D, the experimental results for the third solution process of FIG. 10 are shown with and without Iterative refinement. The experiment data are collected with fine range resolution, which is 6 cm. In the region of [−20°, 20°], there is no range migration, as expected. Thus, in this range, there is no change in the angle estimation error. Overall, this process results in 2-4× reduction in the angle estimation error.

### iv. Corrected Iterative Refinement

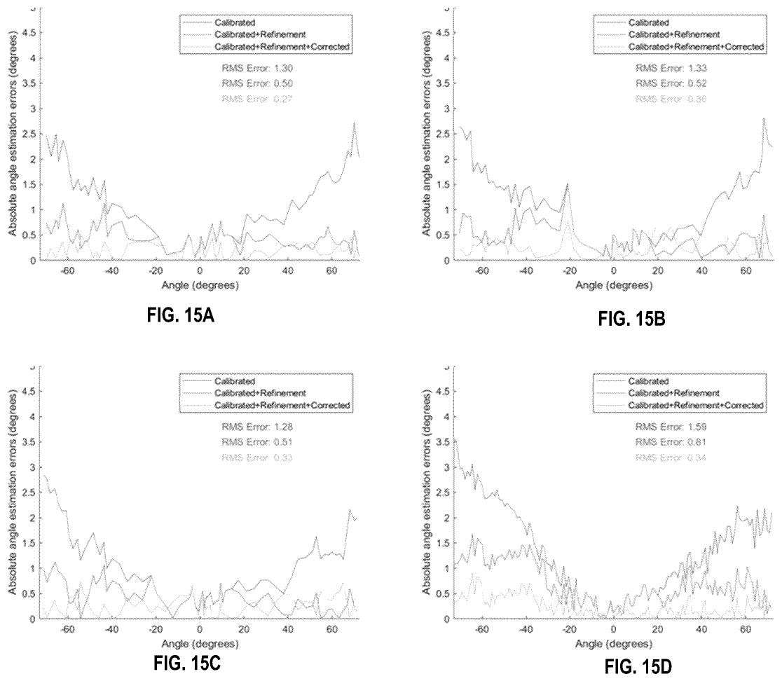

In FIGS. 15A-15D, the experimental results for the fourth solution process of FIG. 11 are shown for three different conditions: with only Calibration which is baseline solution that does not include any improvement, with Iterative refinement after Calibration, and Corrected Iterative refinement after Calibration. The experimental data are collected with fine range resolution, which is 6 cm. The blue line in these figures is common for all proposed solutions. The effect of our innovations are shown with red and yellow lines in FIGS. 15A-15D. Red lines shows the Iterative Refinement process of FIG. 10. In the region of [−20°, 20°], there is no range migration expected and blue and red lines overlap. Yellow lines show the Corrected Iterative Refinement process of FIG. 11. The correction parameters are calculated using one of the experiments. FIGS. 15A-15D shows further improvements on angle estimation with Corrected Iterative Refinement process of FIG. 11. It is clearly seen that Corrected Iterative Refinement process of FIG. 11 achieves the best estimation accuracy, reducing the RMS error by another factor of 2. The overall RMS error becomes less than 0.34° which is best angle estimation accuracy achieved among all the solution processes.

### 4. Computer-Implemented System

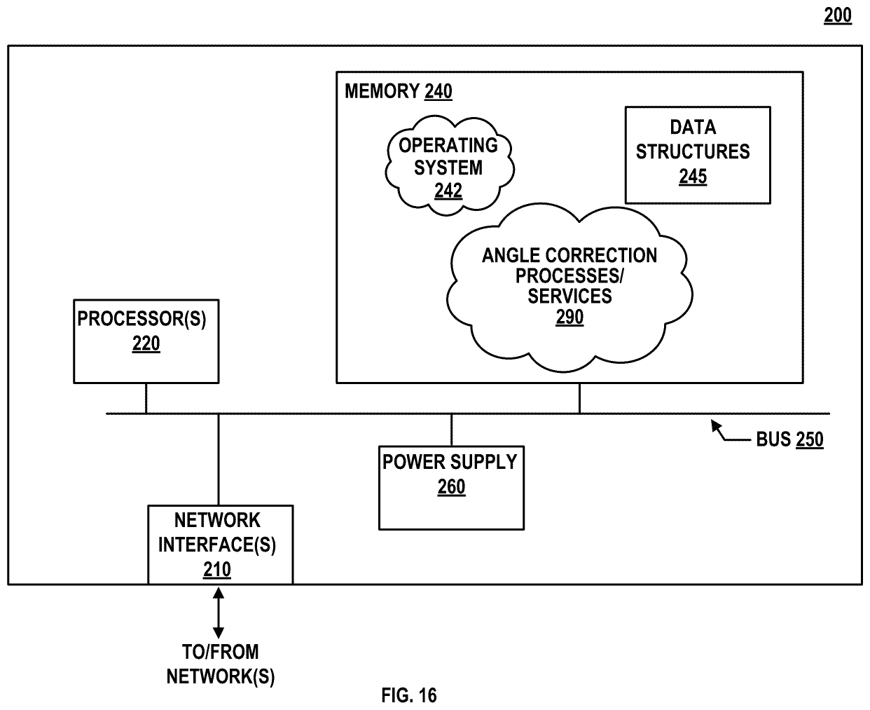

FIG. 16 is a schematic block diagram of an example device 200 that may be used with one or more embodiments described herein, e.g., as a component of system 100 shown in FIG. 6.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system 100 and the first, second, third and fourth solution processes 300, 400, 500 and 600 outlined herein and shown in FIGS. 8-11.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include angle correction processes/services 290, which can include aspects of the first, second, third and fourth solution processes 300, 400, 500 and 600 and any other modules of the system 100 such as those required to generate transmitted signals sent by the transmitter(s) 110 and/or process received signals received at the receiver(s) 120 of the system 100. Note that while angle correction processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the angle correction processes/services 290 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a receiver operable to receive a return signal reflected from an object, the receiver including a plurality of virtual antennae; and
a processor in communication with the receiver and a memory, the memory including instructions executable by the processor to:
determine, by a range and angle estimation process, an angle of arrival of the return signal, the angle of arrival being indicative of an angular position of the object; and
apply an angle correction function to the angle of arrival yielding a corrected angle of arrival, the angle correction function being a polynomial and including a plurality of correction coefficients, wherein the processor is operable to determine the plurality of correction coefficients through at least one of:
simulation of a system model corresponding with a hardware of the receiver;
post-production characterization of an error profile obtained using one or more calibration objects; and/or
iterative fitting of the angle correction function to one or more candidate angles of arrival to determine an optimal set of correction parameters of the angle correction function.

2. The system of claim 1, the angle of arrival being one of a plurality of candidate angles of arrival and the memory further including instructions executable by the processor to:
determine, based on an initial value of the angle of arrival of the return signal, an index error and an updated peak frequency for each respective virtual antenna;
generate an updated set of complex angle data at each updated peak frequency; and
apply a second Fourier Transform operation to the updated set of complex angle data to yield a set of updated transformed angle data.

3. The system of claim 1, the memory further including instructions executable by the processor to apply the range and angle estimation process including:
access a set of signal data indicative of the return signal;
apply a calibration process to the set of signal data yielding a set of calibrated data, the calibration process including a set of saved calibration coefficients that, when applied to the set of signal data, result in the set of calibrated data;
apply a first Fourier Transform operation to the set of calibrated data to yield a set of transformed data by frequency;
determine, based on the set of transformed data, a peak frequency of the return signal;
determine, based on the peak frequency of the return signal, a range of the object that reflected the return signal;
generate a set of complex angle data at the peak frequency;
apply a second Fourier Transform operation to the set of complex angle data to yield a set of transformed angle data; and
determine one or more peak values and a peak angle for each respective peak value from the set of transformed angle data, wherein the peak angle is indicative of an angular position of the object.

4. The system of claim 1, further comprising:
a transmitter operable to transmit a radiofrequency signal whose frequency linearly changes with time within a given bandwidth;
the return signal received at the receiver being resultant of the radiofrequency signal being reflected from the object.

5. A system, comprising:
a receiver operable to receive a return signal reflected from an object, the receiver including a plurality of virtual antennae; and
a processor in communication with the receiver and a memory, the memory including instructions executable by the processor to:
determine, at the processor and by a range and angle estimation process, an angle of arrival of the return signal, the angle of arrival being indicative of an angular position of the object;
iteratively determine, based on an initial value of the angle of arrival of the return signal, an index error and an updated peak frequency for each respective virtual antenna;
iteratively generate an updated set of complex angle data at each updated peak frequency;
iteratively apply a Fourier Transform operation to the updated set of complex angle data to yield a set of updated transformed angle data; and
iteratively determine one or more peak values and a peak angle for each respective peak value from the set of updated transformed angle data, wherein the peak angle is indicative of an angular position of the object.

6. The system of claim 5, the memory further including instructions executable by the processor to:
apply an angle correction function to the angle of arrival yielding a corrected angle of arrival, the angle correction function being a polynomial and including a plurality of correction coefficients, wherein the processor is operable to determine the plurality of correction coefficients through iterative fitting of the angle correction function to one or more candidate angles of arrival to determine an optimal set of correction parameters of the angle correction function.

7. The system of claim 6, the plurality of correction coefficients being determined through at least one of:
simulation of a system model corresponding with a hardware of the receiver;
post-production characterization of an error profile obtained using one or more calibration objects; and/or
iterative fitting of the angle correction function to the one or more candidate angles of arrival to determine the optimal set of correction parameters of the angle correction function.

8. The system of claim 5, the memory further including instructions executable by the processor to apply the range and angle estimation process including:
access a set of signal data indicative of the return signal;
apply a calibration process to the set of signal data yielding a set of calibrated data, the calibration process including a set of saved calibration coefficients that, when applied to the set of signal data, result in the set of calibrated data;
apply a first Fourier Transform operation to the set of calibrated data to yield a set of transformed data by frequency;
determine, based on the set of transformed data, a peak frequency of the return signal;
determine, based on the peak frequency of the return signal, a range of the object that reflected the return signal;
generate a set of complex angle data at the peak frequency;
apply a second Fourier Transform operation to the set of complex angle data to yield a set of transformed angle data; and
determine one or more peak values and a peak angle for each respective peak value from the set of transformed angle data, wherein the peak angle is indicative of an angular position of the object.

9. The system of claim 5, further comprising:
a transmitter operable to transmit a radiofrequency signal whose frequency linearly changes with time within a given bandwidth;
the return signal received at the receiver being resultant of the radiofrequency signal being reflected from the object.

10. A system, comprising:
a receiver operable to receive a return signal reflected from an object, the receiver including a plurality of virtual antennae;
a processor in communication with the receiver and a memory, the memory including instructions executable by the processor to:
access a set of signal data indicative of the return signal;
apply a calibration process to the set of signal data yielding a set of calibrated data, the calibration process including a set of saved calibration coefficients that, when applied to the set of signal data, result in the set of calibrated data;
apply a first Fourier Transform operation to the set of calibrated data to yield a set of transformed data by frequency;
determine, based on the set of transformed data, an average peak value and an average peak frequency associated with the average peak value;
identify, based on the transformed data, a set of individual peak values and a set of individual peak frequencies for each respective virtual antenna of the plurality of virtual antennae within a predetermined bin range of the average peak frequency; and
identify one or more final peak values and one or more final peak angles based on the set of individual peak values, wherein a final peak angle is indicative of an angular position of the object.

11. The system of claim 10, the memory further including instructions executable by the processor to determine the angle of arrival, including:
apply a second Fourier Transform operation to the set of individual peak values and the set of individual peak frequencies for each respective virtual antenna of the plurality of virtual antennae to yield a set of transformed angle data; and
determine the one or more final peak values and the one or more final peak angles for each respective final peak value from the set of transformed angle data, each final peak value of the one or more final peak values corresponding with a virtual antenna of the plurality of virtual antennae.

12. The system of claim 10, further comprising:
a transmitter operable to transmit a radiofrequency signal whose frequency linearly changes with time within a given bandwidth;
the return signal received at the receiver being resultant of the radiofrequency signal being reflected from the object.

13. A method, comprising:
accessing, by a receiver including a plurality of virtual antennae, a return signal reflected from an object;
determining, by a processor in communication with the receiver and a memory, and by a range and angle estimation process, an angle of arrival of the return signal, the angle of arrival being indicative of an angular position of the object; and
applying, by the processor, an angle correction function to the angle of arrival yielding a corrected angle of arrival, the angle correction function being a polynomial and including a plurality of correction coefficients, the processor being operable to determine the plurality of correction coefficients through at least one of:
simulation of a system model corresponding with a hardware of the receiver;
post-production characterization of an error profile obtained using one or more calibration objects; and/or
iterative fitting of the angle correction function to one or more candidate angles of arrival to determine an optimal set of correction parameters of the angle correction function.

14. The method of claim 13, the angle of arrival being one of a plurality of candidate angles of arrival and the method further comprising:
determining, based on an initial value of the angle of arrival of the return signal, an index error and an updated peak frequency for each respective virtual antenna;
generating an updated set of complex angle data at each updated peak frequency; and
applying a second Fourier Transform operation to the updated set of complex angle data to yield a set of updated transformed angle data.

15. The method of claim 13, the range and angle estimation process further including:
receiving, at the plurality of virtual antennae, a set of signal data indicative of the return signal;
applying a calibration process to the set of signal data yielding a set of calibrated data, the calibration process including a set of saved calibration coefficients that, when applied to the set of signal data, result in the set of calibrated data;
applying a first Fourier Transform operation to the set of calibrated data to yield a set of transformed data by frequency;
determining, based on the set of transformed data, a peak frequency of the return signal;
determining, based on the peak frequency of the return signal, a range of the object that reflected the return signal;
generating a set of complex angle data at the peak frequency;
applying a second Fourier Transform operation to the set of complex angle data to yield a set of transformed angle data; and
determining one or more peak values and a peak angle for each respective peak value from the set of transformed angle data, wherein the peak angle is indicative of an angular position of the object.

16. The method of claim 13, further comprising:
transmitting, by a transmitter, a radiofrequency signal whose frequency linearly changes with time within a given bandwidth;
the return signal received at the receiver being resultant of the radiofrequency signal being reflected from the object.

17. A method, comprising:
accessing, at a processor in communication with a memory and from a receiver including a plurality of virtual antennae, a set of signal data indicative of a return signal reflected from an object;
applying a calibration process to the set of signal data yielding a set of calibrated data, the calibration process including a set of saved calibration coefficients that, when applied to the set of signal data, result in the set of calibrated data;
applying a first Fourier Transform operation to the set of calibrated data to yield a set of transformed data by frequency;
determining, based on the set of transformed data, an average peak value and an average peak frequency associated with the average peak value;
identifying, based on the transformed data, a set of individual peak values and a set of individual peak frequencies for each respective virtual antenna of the plurality of virtual antennae within a predetermined bin range of the average peak frequency; and
identifying one or more final peak values and one or more final peak angles based on the set of individual peak values, the one or more final peak angles being indicative of an angular position of the object.

18. The method of claim 17, where determining the angle of arrival includes:
applying a second Fourier Transform operation to the set of individual peak values and the set of individual peak frequencies for each respective virtual antenna of the plurality of virtual antennae to yield a set of transformed angle data; and
determining the one or more final peak values and the one or more final peak angles for each respective final peak value from the set of transformed angle data, each final peak value of the one or more final peak values corresponding with a virtual antenna of the plurality of virtual antennae.

19. The method of claim 17, further comprising:
transmitting, by a transmitter, a radiofrequency signal whose frequency linearly changes with time within a given bandwidth;
the return signal received at the receiver being resultant of the radiofrequency signal being reflected from the object.
